(19) United States
(12) Patent Application Publication
(10) Pub. No.: US 2023/0230180 A1
(43) Pub. Date: Jul. 20, 2023

(54) METHODS AND APPARATUS FOR DLT-ENABLED DIGITIZED TOKENS FOR BASELINE ENERGY USAGE

(71) Applicant: Dynamis Energy, LLC, Eagle, ID (US)

(72) Inventors: Robert W. Abbott, Meridian, ID (US); Kevin W. Malloy, Caldwell, ID (US); Kevin McNulty, Houston, TX (US)

(73) Assignee: Dynamis Energy, LLC, Eagle, ID (US)

(21) Appl. No.: 18/099,284

(22) Filed: Jan. 20, 2023

Related U.S. Application Data
(60) Provisional application No. 63/301,154, filed on Jan. 20, 2022.

(51) Int. Cl. G06Q 50/06; G06Q 20/22; G06Q 20/38; G06Q 30/0283; G06Q 30/04

(52) U.S. Cl. CPC G06Q 50/06; G06Q 20/223; G06Q 20/3827; G06Q 30/0284; G06Q 30/04

(57) ABSTRACT

Disclosed embodiments include methods and computer-implemented distributed ledger technology (“DLT”) systems based at least in part upon electricity usage. Disclosed embodiments include instructions to cause at least one server device and related data processing and storage apparatus to operate over a peer-to-peer network to provide a system having an electricity tracker module that records a transaction comprising an amount of electricity incoming from a power grid and an amount of energy savings from energy savings equipment, along with the environmental and other attributes of such energy, wherein the transaction includes identifying data and the electricity tracker module functions as a node on a DLT network, and wherein the DLT network comprises a plurality of nodes that execute a software verification algorithm that includes a cryptographic hash value based at least in part upon transaction identifying data. Disclosed embodiments also include a predictive analytics module to compare the incoming electricity usage against the amount of energy savings from the energy savings equipment, a timer module to monitor the electricity tracker module through a defined term, and an invoice module for generating an invoice for the energy saved through the defined term.

### CROSS-REFERENCE TO RELATED APPLICATIONS

This application, under 35 U.S.C. § 119, claims the benefit of U.S. Provisional Patent Application Ser. No. 63/301,154 filed on Jan. 20, 2022, and entitled “Base Line Energy Usage,” the contents of which are hereby incorporated by reference herein.

### FIELD OF THE DISCLOSURE

This disclosure relates generally to distributed ledger systems and methods. More particularly, this disclosure relates to systems and methods for distributed ledger creation, tracking and redeeming of digitized tokens related to electricity or baseline energy usage.

### BACKGROUND

A distributed ledger (also referred to herein as a shared ledger or distributed ledger technology or DLT) is a consensus of replicated, shared, and synchronized digital data geographically spread across multiple sites, countries, or institutions. Typically, there is no central administrator or centralized data storage.

A distributed ledger database may be spread across several nodes (e.g., devices) on a peer-to-peer network, where each replicates and saves an identical copy of the ledger and updates itself independently. One advantage is the lack of central authority. When a ledger update happens, each node constructs the new transaction, and then the nodes vote by consensus algorithm on which copy is correct. Once a consensus has been determined, all the other nodes update themselves with the new, correct copy of the ledger. Security is typically accomplished through cryptographic keys and signatures.

A peer-to-peer network is typically required as well as consensus algorithms to ensure replication across nodes is undertaken. One form of distributed ledger design is the blockchain system, which can be either public or private.

Generally, a blockchain is a decentralized, distributed, and oftentimes public, digital ledger that is used to record transactions across many computers so that any involved record cannot be altered retroactively, without the alteration of all subsequent blocks. This allows the participants to verify and audit transactions independently and relatively inexpensively.

A blockchain database is managed autonomously using a peer-to-peer network and a distributed timestamping server. Such a design facilitates robust workflow where participants' uncertainty regarding data security is marginal. The use of a blockchain removes the characteristic of infinite reproducibility from a digital asset. It confirms that each unit of value was transferred only once, solving the long-standing problem of double spending. A blockchain has been described as a value-exchange protocol. A blockchain can maintain title rights because, when properly set up to detail the exchange agreement, it provides a record that compels offer and acceptance. Other forms, functionalities, and types of distributed ledgers, blockchains, and the like, also exist.

Additionally, current energy savings companies (ESCOs) market performance contracts to various commercial and industrial facilities in which the ESCO contracts to provide energy savings equipment, free of charge or at reduced rates, in exchange for being paid a portion of the energy savings that are produced. Thus, the facility keeps some of the savings, but a portion of the energy savings is still paid to the ESCO. The ESCO may also include on-site energy production facilities, such as solar panels, or combined heat and power plants, to reduce cost by producing energy on-site rather than purchasing from a utility or other third party. However, in existing systems there is a constant concern in calculating the savings and determining the actual savings when comparing to a baseline of what the energy usage of the facility would have been without such energy savings or production devices installed. Although this baseline is intended to be a base for comparison for energy usage after implementing the energy savings program, such energy usage can be influenced by a number of external factors such as changes in the weather, changes in facility operations, changes in the practices of employees on site, as well as the new equipment installed or replaced. This frequently leads to disputes between the ESCO and the client as to the basis and the value of the actual energy savings, and, therefore, the payments due to the ESCO. Other issues, drawbacks, and inconveniences with current systems and methods also exist.

### SUMMARY

Accordingly, disclosed embodiments address the above, and other, issues, drawbacks, and inconveniences with current systems and methods. Disclosed embodiments are for tracking the generation and consumption of energy in a facility via systems that provide for physical reading of the actual amount of energy that is generated and/or consumed (e.g., in kilowatt hours (“kWh”), or other measurable property, unit, or metric of electricity or electrical power, such as source of the electric power (from savings, from renewable or fossil fuel sources), carbon intensity, etc., or its calorific value e.g., MMBtu/second, on site and directly compares the changes to equipment made by the ESCO to the facility (by repair, replacement, addition, etc.) with the energy that would have been consumed from such equipment otherwise. The information from a meter reading device is then transmitted to a digital ledger using Distributed Ledger Technology (DLT) through which the savings are then confirmed and validated against the actual equipment usage rather than being compared to a baseline of previous usage. To the extent the value of the savings is enhanced by being derived from renewable resource, energy efficiency, or other means, either through markets, subsidies, or other sources, this can also be tracked. Thus, the actual usage into the facility, or into various equipment in portions of the facility, is metered to confirm the generation, provenance, and/or usage of such energy. This can then be compared against the energy that would have been generated or consumed if not for the equipment installed or replaced in the facility. For example, if reactive power created at a facility is rectified and reduced, the amount of reduction can be determined on a real-time, ongoing basis which is then be converted into a savings adjustment. In other exemplary embodiments, if facility equipment is modified, such as lighting, or replaced, such as air conditioning (or other HVAC systems), the specifications of the changes in lighting or air conditioning can be included in the system database to calculate the savings that occurs from these changes operating over a time frame.

Therefore, the actual savings, or energy production from equipment added to or modified to promote energy savings (or other revenue basis, such as related green energy subsidies), is verified on a real-time basis, and the savings or income to the facility are then calculated with the data in the distributed ledger that determine the energy saved with the actual cost of power purchased from utility or other provider. Through such energy tracking each period of reduced, saved, or recalculated power is validated and recorded as immutable data in the DLT, thereby mitigating disputes related to amounts of real power saved or made available to the facility.

Additionally, the disclosed systems and methods may implement smart contracts. Smart contracts are programs stored on a blockchain that run when predetermined conditions are met. They typically are used to automate the execution of an agreement so that all participants can be immediately certain of the outcome, without any intermediary's involvement or time loss. In some embodiments, a smart contract tied to the DLT automatically authorizes payments to the client or the ESCO based on the calculation by the DLT of the cost of power tied to the time the energy was saved or generated based on utility rate information updated consistent with the utility rate reporting or tied to credits or other benefits associated with the energy usage. Therefore, the performance contract offered by an ESCO on the contractual basis of utilizing the proposed tracking and software is easier to administer and no longer subject to disputes as to the actual savings.

Additionally, in some embodiments the associated metering device is used to accurately track and store additional data about the energy, such as the environmental attributes related to the power produced or saved as noted. This data is then assessed through artificial intelligence (AI) to identify other potential energy savings, or energy trading opportunities, which can then be offered to the client owning the facility, potentially under an additional performance contract, credit, or subsidy. Likewise, the energy savings or production can be tokenized to track the value created through such data related to the energy and used to trade for other value.

Embodiments of the disclosed systems' DLT include a data structure that stores a list of transactions and can be thought of as a distributed electronic ledger that records transactions between source (e.g., Token Generation) and destination (e.g., Token Consumption). Each transaction references the hashes of two or more transactions that precede it. As a result, all transactions are immutable and have a history of references that nodes can traverse to validate their trustworthiness. These transactions are time-stamped (providing a history of the exact moment in time of data creation) when the tokens are generated, which may occur at the production of electricity by a generator, pre-sale of electricity to be generated, or the like.

Embodiments of system architecture encompass light nodes, full nodes, distributed Web Servers, databases and Web Portals in a “nested” structure. As used herein, a “light node” (or “module”) is responsible for collecting time-stamped data (e.g., kWh produced or consumed, and geolocation data) from a meter and working with other light nodes to validate the data.

As used herein a “full node” gathers time-stamped data (transactions) from a group (of any number) of modules (light nodes) and verifies and validates the data.

As used herein “distributed web servers” are servers used for permanent storage of validated data (history of transactions) and maintain records of electricity produced and consumed. Distributed web servers also maintain records of all transactions on the network (e.g., tokens used for payment of goods or services other than consumption of electricity).

As used herein a “web portal” is a web (internet) based user interface used to monitor the system.

Each module represents a light node on the system. There are multiple modules that interact with each other and confirm the validity of the transactions on the system by validating the time stamps between nodes. The validation of the time stamps between all of the interacting modules ensures the veracity of the data. This creates the system's distributed ledger.

The modules also continue to validate the data read by the meter from the generation source, by constantly checking the calibration of the meter through ongoing updates that occur normally with an Advanced Metering Infrastructure (AMI) meter. The system's nodes maintain the distributed ledger and cryptographically validate each new transaction and thus the data contained within. Because the nodes are interconnected in such a way that they share information, when one node receives a transaction it will be forwarded to every other node in the network. This way all nodes in the network can validate all transactions and store them. At given intervals, a snapshot of this data will be taken and stored for future reference.

Disclosed embodiments include a computer-implemented DLT system based at least in part upon electricity usage, the system including instructions to cause at least one server device and related data processing and storage apparatus to operate over a peer-to-peer network to provide a system having an electricity tracker module that records a transaction comprising an amount of electricity incoming from a power grid and an amount of energy savings from energy savings equipment, along with the environmental and other attributes of such energy, wherein the transaction includes identifying data and the electricity tracker module functions as a node on a DLT network, and wherein the DLT network comprises a plurality of nodes that execute a software verification algorithm that includes a cryptographic hash value based at least in part upon transaction identifying data. Disclosed embodiments also include a predictive analytics module to compare the incoming electricity usage against the amount of energy savings from the energy savings equipment, a timer module to monitor the electricity tracker module through a defined term, and an invoice module for generating an invoice for the energy saved through the defined term.

In further disclosed embodiments the cryptographic hash value is additionally based upon at least one prior verified transaction.

In some embodiments the electricity tracker module comprises a physical monitoring device connected to an Advanced Metering Infrastructure (AMI) meter. In still further embodiments the physical monitoring device comprises an American National Standards Institute (ANSI) certified physical monitoring device.

In some embodiments the electricity tracker module communicates with the DLT network through a cellular network connection.

In some embodiments the invoice module for generating an invoice comprises a smart contract.

Also disclosed are computer-implemented methods of operating a DLT token exchange system based at least in part upon electricity usage, the methods including executing instructions to cause at least one server device and related data processing and storage apparatus to operate over a peer-to-peer network to provide a method of recording, with an electricity tracker module, a transaction comprising an amount of electricity incoming from a power grid and an amount of energy savings from energy savings equipment, along with the environmental and other attributes of such energy, wherein the transaction includes identifying data and the electricity tracker module functions as a node on a DLT network, and wherein the DLT network comprises a plurality of nodes that execute a software verification algorithm that includes a cryptographic hash value based at least in part upon transaction identifying data.

In some embodiments the method also includes comparing, with a predictive analytics module, the incoming electricity usage against the amount of energy savings from the energy savings equipment, timing, with a timer module, to monitor the electricity tracker module through a defined term, and generating an invoice, with an invoice module, for the energy saved through the defined term.

In some embodiments of the method the cryptographic hash value is additionally based upon at least one prior verified transaction.

In some embodiments of the method the electricity tracker module comprises a physical monitoring device connected to an Advanced Metering Infrastructure (AMI) meter. In further embodiments the physical monitoring device comprises an American National Standards Institute (ANSI) certified physical monitoring device.

In some embodiments of the method the electricity tracker module communicates with the DLT network through a cellular network connection.

In some embodiments of the method the invoice module for generating an invoice comprises a smart contract. Other embodiments are also possible.

### BRIEF DESCRIPTION OF THE DRAWINGS

FIG. 1 is a schematic overview of an energy credit DLT ecosystem in accordance with disclosed embodiments.

FIG. 2 is a schematic of utility meter in accordance with disclosed embodiments.

FIG. 3 is a schematic flow diagram illustrating electricity and data flow in accordance with disclosed embodiments.

FIG. 4 is a flow chart for an exemplary method in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

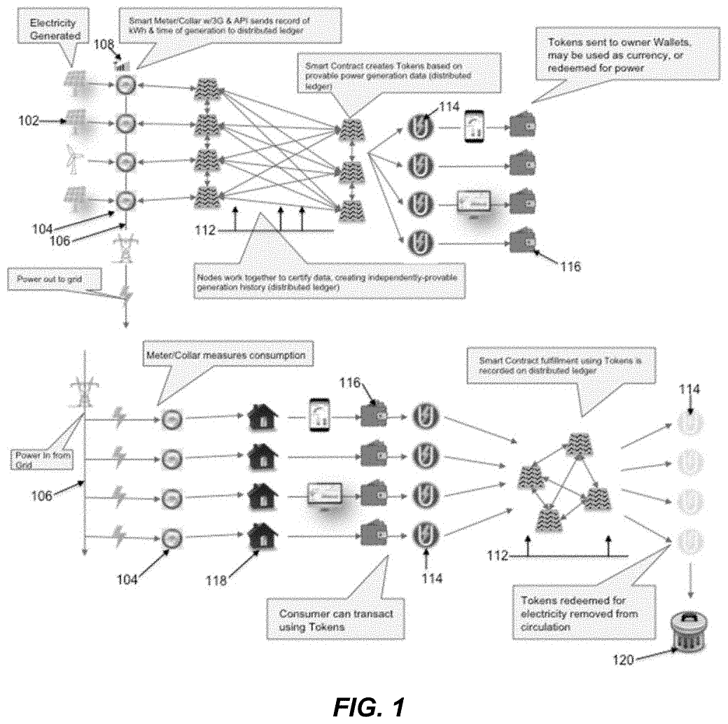

FIG. 1 is a schematic overview of an energy credit DLT ecosystem 100 in accordance with disclosed embodiments. As illustrated, system 100 may include a number of energy generators 102 which may comprise solar, wind, hydro, waste gasifiers, nuclear, coal fired, or the like electrical generation systems.

Electric energy generated by the electrical generators 102 is measured by a module 104 embodiments of which may be an ANSI certified physical monitoring device connected to any standard AMI meter which monitors and stores the measurements of the amount of the flow of electricity measured on a utility feed or interconnect line 106 by such standard AMI meter. Embodiments of module 104 may also store the time history of the electricity flow through the interconnect line 106 (e.g., power grid). Embodiments of module 104 can use public or other cellular communications 108, or other wireless, mesh technology, WiFi, or the like networks to communicate to the nodes of the system distributed ledger 112 to provide an immutable history of the generation of electricity at the attached module 104 location. Geolocation is used through cellular (or other) communications networks 108 to ensure production is from the specific source it is tied to.

As part of the above noted validation process, embodiments of the module 104 receive calibration information from an associated electricity meter as it is calibrated to ensure production of tokens 114 is not manipulated, rigged, or otherwise fraudulently created. The transaction is shared on the system's distributed ledger network 112. As also shown, smart contracts within and across DLT network 112 are used to create tokens 114 based on provable power generation (or other energy related) data and are the transactions that are shared and validated between the nodes. As one of ordinary skill in the art having the benefit of this disclosure would understand, “smart contracts” is an industry term describing a self-executing contract with the terms of the agreement between the buyer and seller being directly written into the lines of software code. The code and the agreements contained therein exist within/across the DLT network 112. The code controls the execution and the transaction is traceable and irreversible.

Embodiments of system 100 include one or more applications (which may be represented by a digital wallet 116) incorporated in the system 100 that allows consumers 118 and producers 102 to access the system 100 token 114 exchange. Embodiments of the system 100 application(s) can be available on any computing device (i.e., smartphone, tablet, or PC, laptop, or the like) and can be used for purchase or sale of goods and services using the token 114, or the trade of tokens 114, on the basis of the underlying value of the token 114 used representing a kilowatt of electricity or other metric or measurable property based on an amount of electricity or power. As the cost of a kilowatt of electricity may vary from region to region, the system 100 also acts as an exchange to equalize the amount of tokens 114 necessary to pay for goods and services in such region. As a result, cross-regional and cross-border trade can be fomented on the basis of a standard set around a kilowatt of electricity, a definable, measurable metric.

As also shown in FIG. 1, feed lines 106 (e.g., from the power grid) provide electricity to power consumers 118 which, as noted herein, may be paid for using tokens 114 stored in the consumer 118 digital wallet 116. Token 114 consumption is recorded on the DLT network 112 and distributed to each node on DLT network 112 and consumed tokens 114 are removed from circulation as indicated at 120.

As will be apparent to those of ordinary skill in the art having the benefit of this disclosure, the system exchange stores an order book in the DLT network 112 and a plurality of digital wallets 116 associated with different clients (e.g., 118). The computer system receives new data transaction requests from the individual modules 104 and/or digital wallets 116 at timed intervals and transactions are added to the order book in the DLT 112. This data (timestamp and transaction information) is then verified by the modules 104 on the network 100. If verification is successful, the transactions are added to the distributed ledger 112. The system 100 then monitors the distributed ledger 112 to determine its ongoing validity. The integrity (e.g., confidence that a previously recorded transaction has not been modified) of the entire distributed ledger 112 is maintained because each transaction refers to or includes a cryptographic hash value, generated in the module 104 at the electrical production facility 102, of the prior transaction.

Generally, a hash is a type of algorithm that takes any input, no matter the length, and outputs a standard-length, random output. This string of characters (output) is the hash, and it is deterministic, meaning the data that is hashed will always produce the same output (string of characters). Accordingly, once a transaction refers to a prior transaction, it becomes difficult to modify or tamper with the data (e.g., the transactions) contained therein. This is because even a small modification to the data will affect the hash value of the entire transaction. Each additional transaction increases the difficulty of tampering with the contents of an earlier transaction. Thus, even though the contents of a distributed ledger (e.g., 112) may be available for all to see, they become practically immutable.

As noted, consumers 118 can purchase tokens 114 through a pre-purchase of electricity from a generator 102. These tokens 114 can be used or exchanged with other consumers 118 for goods and services. The tokens 114 can be used multiple times for multiple transactions and are only redeemed when used for purchase of electricity from a generator 102 within the system 100, which then takes that token 114 out of circulation as shown at 120. Generators 102 that produce the tokens 114 may also sell or exchange the tokens 114 with other consumers 118 for goods or services. In a like manner, characteristics of the energy associated with the token, can be traded as part and parcel of the energy, or potentially be traded separately.

In some embodiments, consumers 118 may also include modules 104 (e.g., AMI meters with modules 104) to measure their electric consumption or energy usage. This data may be stored in their digital wallet 116 and can serve as the basis for payment through tokens 114 stored on the digital wallet 116. The module 104 itself may also be used as a node on DLT network 112 to help in validating transactions on the distributed ledger 112.

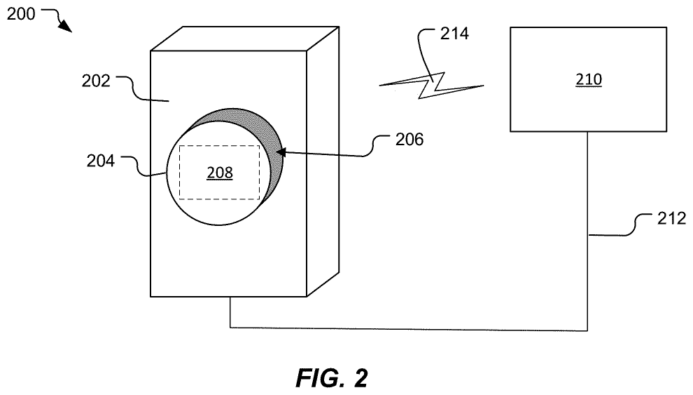

FIG. 2 is a schematic of utility meter 200 in accordance with disclosed embodiments. Embodiments of utility meter 200 may include metering equipment 202 mounted to, or near, a facility where energy consumption/creation/saving is desired to be monitored in accordance with disclosed embodiments. Embodiments of utility meter 200 include a kWh meter display 204 mounted via a collar 206 to the metering equipment 202. Other embodiments and types (e.g., digital, smart, or the like) of utility meters 200 may also be used.

Embodiments of utility meter 200 also include a data tracking device 208 (also referred to herein as “tracker”) which includes one or more circuit boards and associated software that connect to the facility's electrical circuits 210 being monitored as part of the energy savings program in order to determine the energy usage in the equipment (including its characteristics), or sector of the building, for which the tracker 208 has been connected. Embodiments of the tracker 208 can be incorporated directly within the existing electric utility meter 200 already utilized by the utility on site (e.g., through prior permission or arrangement with the meter supplier) or attached to an existing utility meter 200 through collar 206 that fits to the existing meter 200. Embodiments of collar 206 are designed to fit with any size or type of smart or other meter through standard size couplings. The tracker 208 collects the information on the electricity use from the client's site and equipment installed 210 at the client's site on an ongoing basis, stores it, and then transmits it to the DLT 218. Depending on the size of the facility, multiple metering devices 200 may be employed.

The tracker 208 also reads information relating to the energy used in the facility, depending on the equipment 210 that is the source of use (e.g., lighting, air conditioning, refrigeration, electric vehicle charging, etc.). In some embodiments the energy savings equipment 210 installed may communicate with the tracker 208 through a wired (212) or wireless (214) system.

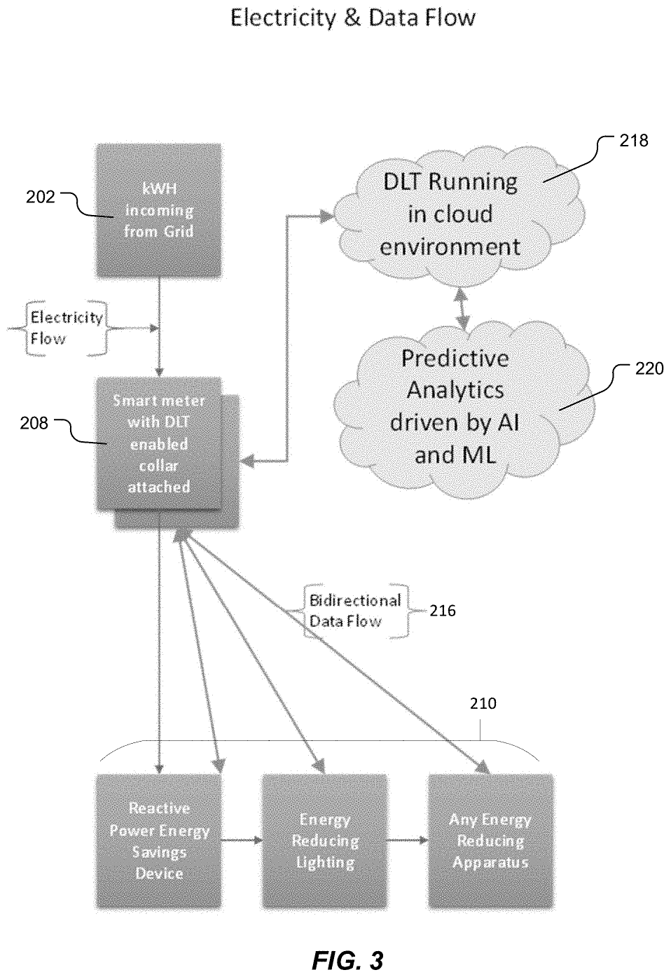

FIG. 3 is a schematic flow diagram illustrating electricity and data flow in accordance with disclosed embodiments. As the bi-directional data 216 is measured and collected, the data is transmitted into the tracker 208 which will then upload the data to the DLT 218. The DLT 218, in this example running in a cloud environment, then verifies and validates the data 216 through comparison of a time stamp and other signatures available in the cloud environment. In some embodiments the data is communicated to the DLT 218 by the tracker 208 through a cellular connection, for example, contracted with a cellular service.

The data 216 is then run through predictive analytics 220 to compare the energy usage against the calculations of the energy usage utilizing the previous installed or replaced equipment, the specifications of which may be stored also in DLT 218 in the cloud-based environment. The difference calculated between the actual energy usage and the predicted energy usage is then also be verified and validated. This data 216 may be collected continuously through a defined term (e.g., one month), at which point the total savings for such period will be determined and the client invoiced automatically for the energy saved through a smart contract tied to the DLT 218, based on contract parameters agreed between the client and the ESCO. The smart contract can generate and publish the data and demonstrate validation through the DLT.

As data is collected by the tracker 208 from the facility meter itself as well as directly from the energy savings devices installed, AI and machine learning algorithms 220 can then be applied to analyze the data 216 stored in the DLT 218 providing predictive analytics to the client based on all the various attributes collected by the tracker 208. This optimizes energy usage and preventive maintenance measures to ensure optimal cost reduction.

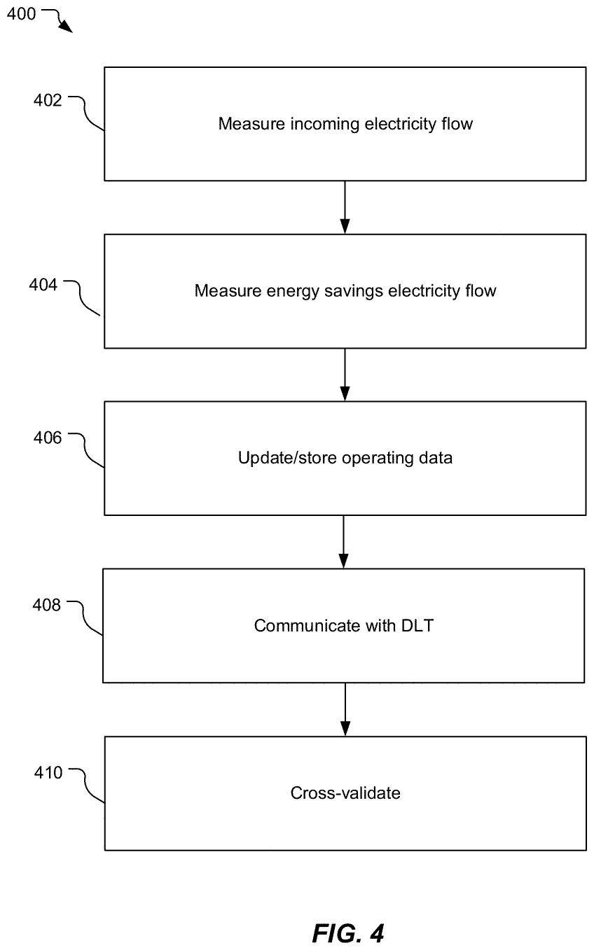

FIG. 4 is a flow chart for an exemplary method 400 in accordance with disclosed embodiments. As shown at 402 meters 200 measure electricity flow into the facility, which is also read by a tracker 208. At 204 electrical usage at various energy savings or generation equipment 210 installed at the site by the ESCO is also measured and sent to the tracker 208 by internal wireless or wired networks. At 406 operating data and specifications for the equipment modified or replaced is stored in the DLT 218. As indicated at 408 and as should be apparent from the present disclosure, each tracker 208 is a node that feeds generation and energy related data 216 through a cellular or other connection to the DLT 218 stored in the cloud. As indicated at 410 each node (e.g., tracker 208) in the DLT 218 cross-validates the data 216 with other nodes as well as with time stamps and other data available through the cloud.

As will be understood by those of ordinary skill in the art having the benefit of this disclosure, data 216 loss is protected from network failure by the distributed nature of the DLT 218. As disclosed herein embodiments may be cell network enabled (i.e., reliable communications that may be “always on”). Additionally, the tracker 208 is designed to be “agnostic” to the meter installation and is not tied to any particular meter type or manufacturer and can be provided with the facility utility meter 200 or retrofitted to existing smart meters. The DLT 218 is utilized to calculate the actual energy savings versus the predicted energy usage and determines the payments due on a periodic basis, based on parameters agreed between the client and the ESCO. The smart contracts automatically process payments to the ESCO based on the savings calculated and the relevant parameters agreed and incorporated in the smart contract.

As also will be understood by those of ordinary skill in the art having the benefit of this disclosure, numerous application of the disclosed systems and methods are possible. For example, in energy service or performance contracts, the energy tracking systems accurately track each block of reduced, saved or recalculated power in the immutable DLT 218 stopping disputes related to how much real power was actually saved or made available to the facility. Additionally, the tracking system can be used to accurately track and store all environmental attributes related to the power produced or saved, such as all types of global carbon credits, green energy production tax credits, green energy investment tax credits, low carbon fuel standard credits, various other local and municipality specific credits, and the like. Further, the verification of these credits through the applied DLT 218, combined with data available on the value of such credits, would allow for trading of such credits and other enhancements. Likewise, the operating characteristics of the energy savings device may also be stored in a DLT 218 along with the measured operating data to be utilized by AI and/or machine learning programs to determine when maintenance or replacement might be required. Other embodiments and application are also possible.

Although various embodiments have been shown and described, the present disclosure is not so limited and will be understood to include all such modifications and variations would be apparent to one skilled in the art.

What is claimed is:

1. A computer-implemented distributed ledger technology (“DLT”) system based at least in part upon electricity usage, the system comprising:
instructions to cause at least one server device and related data processing and storage apparatus to operate over a peer-to-peer network to provide a system comprising:
an electricity tracker module that records a transaction comprising an amount of electricity incoming from a power grid and an amount of energy savings from energy savings equipment, along with the environmental and other attributes of such energy;
wherein the transaction includes identifying data and the electricity tracker module functions as a node on a DLT network; and
wherein the DLT network comprises a plurality of nodes that execute a software verification algorithm that includes a cryptographic hash value based at least in part upon transaction identifying data;
a predictive analytics module to compare the incoming electricity usage against the amount of energy savings from the energy savings equipment;
a timer module to monitor the electricity tracker module through a defined term; and
an invoice module for generating an invoice for the energy saved through the defined term.

2. The DLT system of claim 1, wherein the cryptographic hash value is additionally based upon at least one prior verified transaction.

3. The DLT system of claim 1 wherein the electricity tracker module comprises a physical monitoring device connected to an Advanced Metering Infrastructure (AMI) meter.

4. The DLT system of claim 3 wherein the physical monitoring device comprises an American National Standards Institute (ANSI) certified physical monitoring device.

5. The DLT system of claim 1 wherein the electricity tracker module communicates with the DLT network through a cellular network connection.

6. The DLT system of claim 1 wherein the invoice module for generating an invoice comprises a smart contract.

7. A computer-implemented method of operating a distributed ledger technology (“DLT”) token exchange system based at least in part upon electricity usage, the method comprising:
executing instructions to cause at least one server device and related data processing and storage apparatus to operate over a peer-to-peer network to provide a method comprising:
recording, with an electricity tracker module, a transaction comprising an amount of electricity incoming from a power grid and an amount of energy savings from energy savings equipment, along with the environmental and other attributes of such energy;
wherein the transaction includes identifying data and the electricity tracker module functions as a node on a DLT network; and
wherein the DLT network comprises a plurality of nodes that execute a software verification algorithm that includes a cryptographic hash value based at least in part upon transaction identifying data;
comparing, with a predictive analytics module, the incoming electricity usage against the amount of energy savings from the energy savings equipment;
timing, with a timer module, to monitor the electricity tracker module through a defined term; and
generating an invoice, with an invoice module, for the energy saved through the defined term.

8. The DLT method of claim 7, wherein the cryptographic hash value is additionally based upon at least one prior verified transaction.

9. The DLT method of claim 7 wherein the electricity tracker module comprises a physical monitoring device connected to an Advanced Metering Infrastructure (AMI) meter.

10. The DLT method of claim 9 wherein the physical monitoring device comprises an American National Standards Institute (ANSI) certified physical monitoring device.

11. The DLT method of claim 7 wherein the electricity tracker module communicates with the DLT network through a cellular network connection.

12. The DLT method of claim 7 wherein the invoice module for generating an invoice comprises a smart contract.
